(19) United States
(12) Patent Application Publication
(10) Pub. No.: US 2017/0329587 A1
(43) Pub. Date: Nov. 16, 2017

(54) PROGRAM CONVERSION METHOD USING COMMENT-BASED PSEUDO-CODES AND COMPUTERREADABLE RECORDING MEDIUM, ONTO WHICH PROGRAM IS RECORDED, FOR IMPLEMENTING

(71) Applicants: KI HONG JOO, SEOUL (KR); JAE HAN KIM, DAEJEON (KR)

(72) Inventors: KI HONG JOO, SEOUL (KR); JAE HAN KIM, DAEJEON (KR)

(21) Appl. No.: 15/524,248

(22) PCT Filed: Nov. 9, 2015
(86) PCT No.: PCT/KR2015/011981

§ 371 Date: May 3, 2017

(30) Foreign Application Priority Data
Nov. 11, 2014 (KR) 10-2014-0155926

(51) Int. Cl. G06F 9/45; G06F 9/44

(52) U.S. Cl. CPC G06F 8/51; G06F 8/75

(57) ABSTRACT

The present invention relates to a program conversion method using comment-based pseudo-codes and a computer-readable recording medium, onto which a program is recorded, for implementing the method, and the method by which a computer system converts a program by using comment-based pseudo-codes comprises the steps of: analyzing codes written in a universal programming language so as to confirm pseudo-codes expressed in comments; generating codes, written in a parallel programming language, by converting codes, if the codes belong to a pseudo-code area, into structure members by using the parallel programming language formed to be executed on one or more data parallel compute nodes, or by converting the same into kernel functions, and by converting codes, if the codes belong to the remaining areas, into host codes of the parallel programming language; and simultaneously executing the kernel functions of the generated codes by using the data parallel compute nodes.

### TECHNICAL FIELD

The present invention relates to a method of transforming a program using annotation-based pseudocode and a computer-readable recording medium having recorded thereon a program for executing the method and, more particularly, to a method of transforming a program using annotation-based pseudocode to transform code written in a general-purpose programming language into code executable by data-parallel (DP)-optimal compute nodes (e.g., graphics processing units (GPUs)), by inserting pseudocode into an annotation statement, and a computer-readable recording medium having recorded thereon a program for executing the method.

### BACKGROUND ART

Computer systems mostly include one or more general-purpose processors (e.g., central processing units (CPUs)) and one or more specialized data-parallel (DP)-optimal compute nodes (e.g., graphics processing units (GPUs)), or single instruction, multiple data (SIMD) units in CPUs. The general-purpose processors generally perform general-purpose processing in the computer systems, and the DP-optimal compute nodes generally perform data-parallel processing (e.g., graphics processing) in the computer systems.

The general-purpose processors mostly have a capability of implementing DP algorithms without optimized hardware resources found in the DP-optimal compute nodes. Consequently, general-purpose processors may be much less efficient than the DP-optimal compute nodes in terms of execution of the DP algorithms.

To create a program executed by the DP-optimal compute nodes such as GPUs, a software development kit (SDK), a library, a dedicated compiler, or the like should be used to support GPU devices, provided functions should be understood, and coding should be performed using additional special grammar.

Therefore, to allow program code dedicated to conventional general-purpose processors (e.g., CPUs) to be executed by DP-optimal compute nodes (e.g., GPUs), modification and supplementation are required, and many difficulties and restrictions can occur without experience in hardware characteristics of the DP-optimal compute nodes.

(Patent Document 1) Korean Patent Registration No. 1,118,321, entitled ‘EXECUTION OF RETARGETTED GRAPHICS PROCESSOR ACCELERATED CODE BY A GENERAL PURPOSE PROCESSOR’

### DISCLOSURE

### Technical Problem

Therefore, the present invention has been made in view of the above problems, and it is one object of the present invention to provide a method of transforming a program using annotation-based pseudocode to transform code written in a general-purpose programming language into code executable by data-parallel (DP)-optimal compute nodes (e.g., graphics processing units (GPUs)), by inserting pseudocode into an annotation statement, and a computer-readable recording medium having recorded thereon a program for executing the method.

### Technical Solution

In accordance with one aspect of the present invention, provided is a method of transforming a program using annotation-based pseudocode by a computer system, the method including analyzing code written in a general-purpose programming language, to check pseudocode expressed as an annotation, transforming code belonging to a pseudocode domain into a struct structure member or into a kernel function using a data-parallel programming language configured to be executed by one or more data-parallel (DP)-optimal compute nodes, and transforming code belonging to another domain into host code of the data-parallel programming language, to generate code written in the data-parallel programming language, and simultaneously executing the kernel function of the generated code using the DP-optimal compute nodes.

The pseudocode may include a domain state variable or a parallelization variable, code belonging to a domain state variable domain may be transformed into the struct structure member using the data-parallel programming language, and code belonging to a parallelization variable domain may be transformed into the kernel function using the data-parallel programming language.

In accordance with another aspect of the present invention, provided is a computer-readable recording medium having recorded thereon a program for executing a method of transforming a program using annotation-based pseudocode by a computer system, the method including analyzing code written in a general-purpose programming language, to check pseudocode expressed as an annotation, transforming code belonging to a pseudocode domain into a struct structure member or into a kernel function using a data-parallel programming language configured to be executed by one or more data-parallel (DP)-optimal compute nodes, and transforming code belonging to another domain into host code of the data-parallel programming language, to generate code written in the data-parallel programming language, and simultaneously executing the kernel function of the generated code using the DP-optimal compute nodes.

### Advantageous Effects

As apparent from the fore-going, since code written in a general-purpose programming language is transformed into code executable by data-parallel (DP)-optimal compute nodes (e.g., graphics processing units (GPUs)) by inserting pseudocode into an annotation statement, context of the code written in the input language may not be changed, and it may be easily verified whether transformation is properly performed, through comparison with a result of executing the transformed output program by the DP-optimal compute nodes. As such, a time taken to port programs from general-purpose processors (e.g., central processing units (CPUs)) to the DP-optimal compute nodes (e.g., GPUs) may be reduced, and productivity may be increased.

In addition, a program written in an existing general-purpose programming language may be easily transformed into a parallel program executable by the DP-optimal compute nodes, without knowledge about a data-parallel programming language executable by the DP-optimal compute nodes.

### DESCRIPTION OF DRAWINGS

FIG. 1 is a block diagram of a computer system for transforming a program using annotation-based pseudocode, according to an embodiment of the present invention;

FIG. 2 shows an example of a program for describing a method of transforming code written in a general-purpose programming language into code written in a data-parallel programming language, by inserting pseudocode as an annotation, according to an embodiment of the present invention;

FIG. 3 is a flowchart of a method of transforming a program using annotation-based pseudocode by a host, according to an embodiment of the present invention;

FIG. 4 shows an example of a program for describing a method of transforming a program using annotation-based pseudocode, according to an embodiment of the present invention; and

FIG. 5 is a flowchart of a method of transforming code written in a general-purpose programming language into code written in a data-parallel programming language, according to an embodiment of the present invention.

### MODE OF THE INVENTION

Details of the above-described aspects, features, and effects of the present invention will become apparent from the following detailed description of the invention, the accompanying drawings, and the appended claims.

Hereinafter, “a method of transforming a program using annotation-based pseudocode and a computer-readable recording medium having recorded thereon a program for executing the method” according to the present invention are described in detail with reference to the accompanying drawings. Embodiments described herein are provided for one of ordinary skill in the art to easily understand the technical features of the present invention, and the present invention is not limited to the embodiments. Furthermore, illustrations of the drawings are provided to easily describe the embodiments of the present invention, and may differ from actually implemented forms thereof.

Components described herein are merely examples for implementing the present invention. Accordingly, in other embodiments of the present invention, other components may be used without departing from the spirit and scope of the present invention. Furthermore, each component may be configured as only a hardware or software component, or configured as a combination of various hardware and software components for performing the same function.

It should be understood that expressions “comprises”, “comprising”, “includes” and/or “including” are “open” expressions, and specify the presence of stated components but do not preclude the presence or addition of other components.

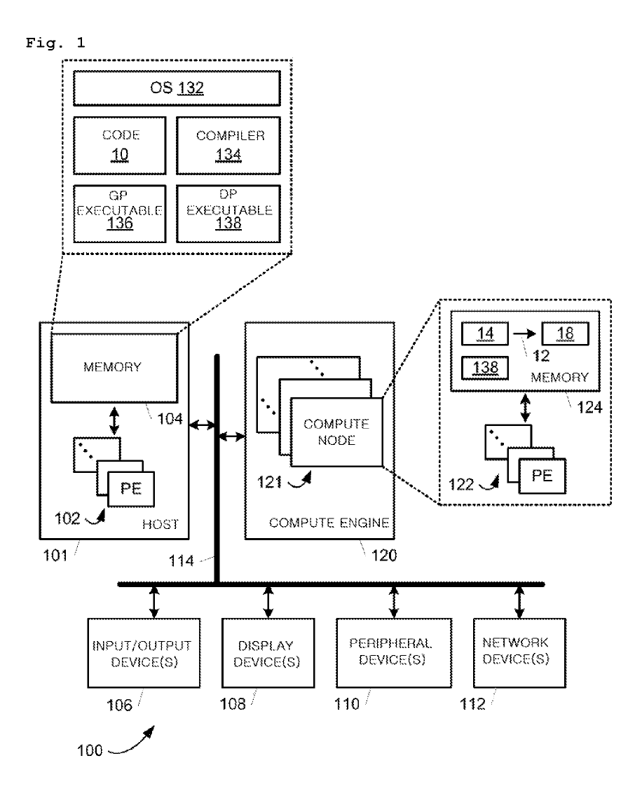

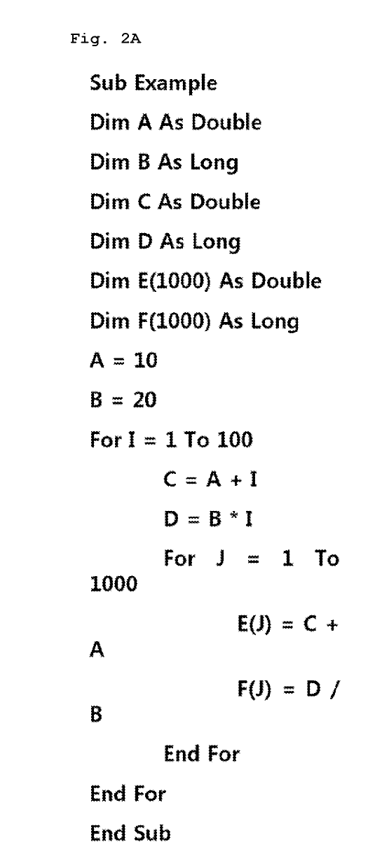

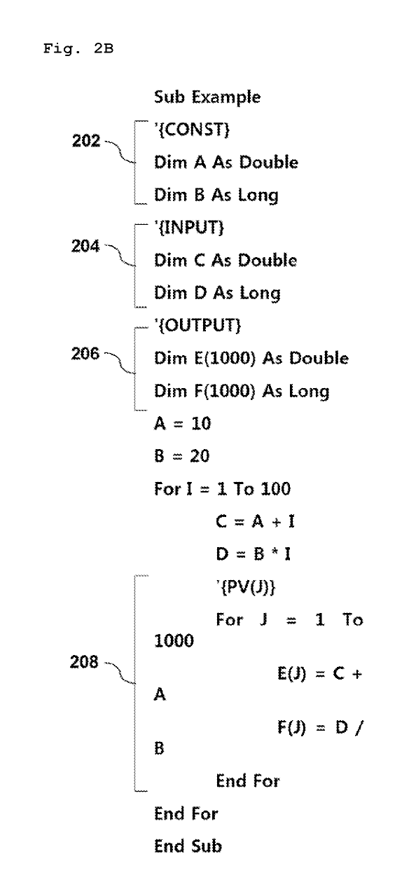

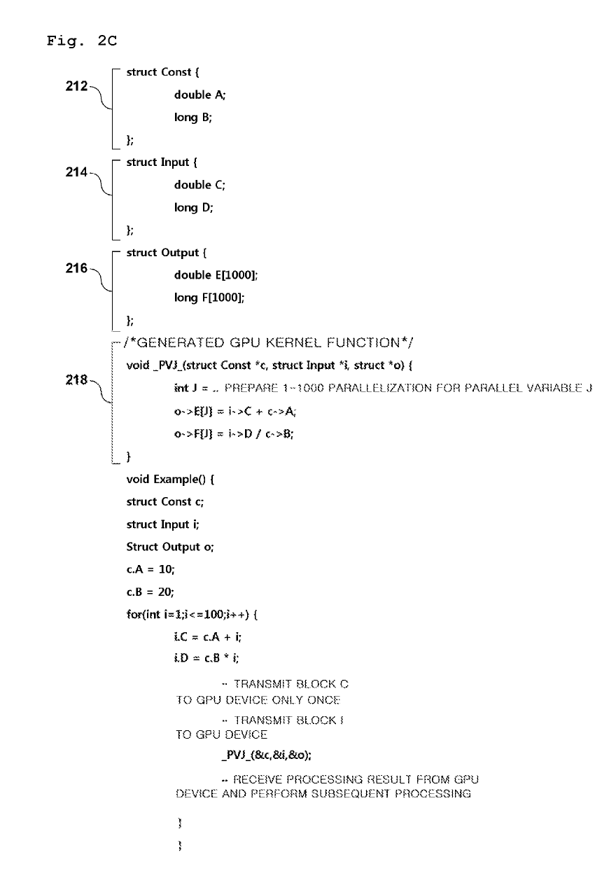

FIG. 1 is a block diagram of a computer system 100 for transforming a program using annotation-based pseudocode, according to an embodiment of the present invention, and FIG. 2 shows an example of a program for describing a method of transforming code written in a general-purpose programming language into code written in a data-parallel programming language, by inserting pseudocode as an annotation, according to an embodiment of the present invention.

Referring to FIG. 1, the computer system 100 includes a host 101 having one or more processing elements (PEs) 102 accommodated in one or more processor packages (not shown), and a memory 104, zero or more input/output devices 106, zero or more display devices 108, zero or more peripheral devices 110, zero or more network devices 112, and a compute engine 120 having one or more data-parallel (DP)-optimal compute nodes 121 each including one or more PEs 122 and a memory 124 for storing DP executable files 138.

The host 101, the input/output devices 106, the display devices 108, the peripheral devices 110, the network devices 112, and the compute engine 120 communicate with each other using a set of interconnections 114 including any suitable type, number, and configuration of controllers, buses, interfaces, and/or other wired or wireless connections.

The computer system 100 is a processing device configured for a general-purpose or a special purpose and may include, for example, a server, a personal computer (PC), a laptop computer, a tablet computer, a smartphone, a personal digital assistant (PDA), a mobile phone, or an audio/video (A/V) device.

The components of the computer system 100 (i.e., the host 101, the input/output devices 106, the display devices 108, the peripheral devices 110, the network devices 112, the interconnections 114, and the compute engine 120) may be contained in a common housing (not shown) or in any suitable number of individual housings (not shown).

The host 10 analyzes code written in a general-purpose programming language, to determine whether pseudocode expressed as an annotation is present. If pseudocode expressed as an annotation is present, the host 10 determines whether the pseudocode corresponds to a domain state variable or a parallelization variable. Herein, the pseudocode includes the domain state variable and the parallelization variable (PV). The domain state variable is used to designate a local or global variable declaration domain. A variable designated by the domain state variable is used in a domain based on the parallelization variable. If a variable other than the variable designated by the domain state variable is used in the domain based on the parallelization variable, the other variable is regarded as a local variable only used within a kernel function. A pseudo-instruction used to designate a variable domain includes, for example, CONST, INPUT, and OUTPUT. The CONST and INPUT domains correspond to a collection of read-only variables used in a PV domain. The CONST domain is a space where, once a program is initialized, the program is not changed until the program ends, and the INPUT domain may set information required for parallel computing immediately before entering the PV domain. If the PV domain is executed only once, INPUT does not have any difference from CONST. The OUTPUT domain is used to return an execution result and is generally prepared in an array having a size of the parallelization variable specified as PV (variable name).

A basic data-type variable or a variable declared in a multi-dimensional array or an explicitly defined structure may be provided in the variable domain.

The parallelization variable is a pseudo-instruction for designating a loop statement to be parallelized. For example, when the parallelization variable is denoted by PV (variable name), a PV pseudo-instruction is provided in front of a loop statement such as FOR or WHILE. In this case, since parallelization is performed using the variable name designated by PV( ), transformed graphics processing unit (GPU) code does not iterate the loop but is simultaneously executed by the loop size. Therefore, code in an iteration statement should not have dependency of using a result of a previous iteration statement.

Although CONST, INPUT, OUTPUT, and PV (variable name) are described as the pseudocode herein, the pseudocode may use different names. In addition, the pseudocode may be defined to designate a range (domain). That is, each piece of pseudocode may be defined to indicate the start and end of a domain designated by the pseudocode.

If the pseudocode corresponds to a domain state variable, the host 101 transforms code belonging to a domain state variable domain into a struct structure member using a data-parallel programming language. If the pseudocode corresponds to a parallelization variable, the host 101 transforms code belonging to a parallelization variable domain into a kernel function using the data-parallel programming language. Otherwise, if the code belongs to a domain where pseudocode is not present, the host 10 transforms the code into host code of the data-parallel programming language. Herein, the data-parallel programming language may be a language configured to be executed by one or more DP-optimal compute nodes. The host code is contrasted with kernel code, and is not executed by the DP-optimal compute nodes. Accordingly, the kernel code is processed in parallel by the DP-optimal compute nodes, and the host code is not processed in parallel.

The host 10 allows the kernel function of the code transformed into the data-parallel programming language to be executed using the DP-optimal compute nodes, and receives results thereof. In this case, the DP-optimal compute nodes simultaneously perform the same operation due to the kernel function. That is, the host 10 parallel-processes the code belonging to a domain where pseudocode is present, using the DP-optimal compute nodes, and does not parallel-process the code belonging to a domain where pseudocode is not present.

The host 101 includes the PEs 102 and the memory 104.

The PEs 102 of the host 101 may form execution hardware configured to execute instructions (i.e., software) stored in the memory 104. The PEs 102 in different processor packages may have equal or different architectures and/or instruction sets. For example, the PEs 102 may include any combination of in-order execution elements, superscalar execution elements, and data-parallel execution elements (e.g., GPU execution elements). Each of the PEs 102 is configured to access and execute instructions stored in the memory 104. The instructions may include a basic input/output system (BIOS) or firmware (not shown), an operating system (OS) 132, code 10, a compiler 134, GP executable files 136, and DP executable files 138. Each of the PEs 102 may execute the instructions in conjunction with or in response to information received from the input/output devices 106, the display devices 108, the peripheral devices 110, the network devices 112, and/or the compute engine 120.

The host 101 boots or executes the OS 132. The OS 132 includes instructions executable by the PEs 102 to provide functions of managing the components of the computer system 100 and allowing a program to access and use the components. The OS 132 may include, for example, Windows operating system or another operating system suitable for the computer system 100.

When the computer system 100 executes the compiler 134 to compile the code 10, the compiler 134 generates one or more executable files, e.g., one or more GP executable files 136 and one or more DP executable files 138. The GP executable files 136 and/or the DP executable files 138 are generated in response to an invocation of the compiler 134 having data-parallel expansions to compile all or selected parts of the code 10. The invocation may be generated by, for example, a programmer or another user of the computer system 100, other code in the computer system 100, or other code in another computer system (not shown).

The code 10 includes a sequence of instructions from a general-purpose programming language (hereinafter referred to as a GP language) that can be complied into one or more executable files (e.g., the DP executable files 138) to be executed by the DP-optimal compute nodes 121.

The GP language should be able to express an annotation statement, provide a loop command (e.g., for or while), and explicitly declare variables.

The GP language may allow a program to be written in different parts (i.e., modules), and thus the modules may be stored in individual files or locations accessible by a computer system. The GP language provides a single language for programming a computing environment including one or more general-purpose processors and one or more special-purpose DP-optimal compute nodes. The DP-optimal compute nodes typically are graphics processing units (GPUs) or single instruction, multiple data (SIMD) units of general-purpose processors. However, in some computing environments, the DP-optimal compute nodes may include scalar or vector execution units of general-purpose processors, field programmable gate arrays (FPGAs), or other suitable devices. Using the GP language, a programmer may include general-purpose processor and DP source code to be executed by general-purpose processors and DP-optimal compute nodes, in the code 10, and coordinate execution of the general-purpose processor and DP source code. In this embodiment, the code 10 may represent any suitable type of code, e.g., an application, a library function, or an operating system service.

The GP language may be formed by expanding a broadly used general-purpose programming language, e.g., C or C++, to include DP features. Other examples of the general-purpose programming language having DP features include Java™, PHP, Visual Basic, Perl, Python™, C#, Ruby, Delphi, Fortran, VB, F#, OCaml, Haskell, Erlang, NESL, Chapel, and JavaScript™. The GP language may include a rich linking capability that allows different parts of a program to be included in different modules. The DP features provide programming tools using the special-purpose architecture of DP-optimal compute nodes for faster and more efficient execution of DP operations compared to general-purpose processors. The GP language may also be another suitable general-purpose programming language that allows programming of a programmer for both the general-purpose processors and the DP-optimal compute nodes.

A DP language provides programming tools using the special-purpose architecture of DP-optimal compute nodes for faster and more efficient execution of DP operations compared to general-purpose processors. The DP language may be an existing data-parallel programming language, e.g., HLSL, GLSL, Cg, C, C++, NESL, Chapel, CUDA, OpenCL, Accelerator, Ct, PGI GPGPU Accelerator, CAPS GPGPU Accelerator, Brook+, CAL, APL, Fortran 90 (or higher), Data-parallel C, DAPPLE, or APL.

Each DP-optimal compute node 121 has one or more computer resources having a hardware architecture optimized for data-parallel computing (i.e., execution of a DP program or algorithm).

A method of transforming code written in a GP language into code written in a DP language, by inserting pseudocode as an annotation will now be described with reference to FIG. 2.

If pseudocode is designated in code written in Visual Basic for Applications (VBA) as illustrated in FIG. 2A, code illustrated in FIG. 2B is obtained. That is, if a programmer adds domain state variables such as CONST 202, INPUT 204, and OUTPUT 206 and a parallelization variable such as PV(j) 208 as an annotation to the code written in VBA as illustrated in FIG. 2A, the code illustrated in FIG. 2B is obtained. The code into which the domain state variables and the parallelization variable are inserted as illustrated in FIG. 2B may be transformed into GPU-based C++ as illustrated in FIG. 2C so as to be executable by a GPU. That is, code belonging to a domain of the CONST 202 is transformed into a struct structure member 212, code belonging to a domain of the INPUT 204 is transformed into a struct structure member 214, and code belonging to a domain of the OUTPUT 206 is transformed into a struct structure member 216. Code belonging to a domain of the parallelization variable PV(j) 208 is transformed into a GPU kernel function 218.

The compiler 134 transforms the GP executable files 136 into the DP executable files 138. The GP executable files 136 and/or the DP executable files 138 are generated in response to a call of the compiler 134 having data-parallel expansions to compile all or selected parts of the code 10. The call may be generated by, for example, a programmer or another user of the computer system 100, other code in the computer system 100, or other code in another computer system (not shown).

For example, the compiler 134 transforms the variables belonging to the variable domains in FIG. 2B into GPU C++ as illustrated in FIG. 2C, defines the same as struct structure members, and replaces variable declarations with structure variable declarations. Thereafter, all code using these variables is transformed to be used as members of a structure. As such, this structure is used for data transmission between the host 101 and the DP-optimal compute nodes 121.

The GP executable files 136 represent a program intended to be executed by the general-purpose PEs 102 (e.g., central processing units (CPUs)). The GP executable files 136 include low-level instructions of instruction sets of the general-purpose PEs 102.

The DP executable files 138 represent a data-parallel program or algorithm (e.g., a shader) which is intended and optimized to be executed by the DP-optimal compute nodes 121. In other embodiments, the DP executable files 138 include low-level instructions of instruction sets of the DP-optimal compute nodes 121, and the low-level instructions were inserted by the compiler 134. Accordingly, the GP executable files 136 may be directly executed by one or more general-purpose processors (e.g., CPUs), and the DP executable files 138 may be directly executed by the DP-optimal compute nodes 121, or may be transformed into low-level instructions of the DP-optimal compute node 121 and then executed by the DP-optimal compute nodes 121.

The computer system 100 may execute the GP executable files 136 using the PEs 102, and may execute the DP executable files 138 using the PEs 122.

The memory 104 includes any suitable type, number, and configuration of volatile or non-volatile storage devices configured to store instructions and data. The storage devices of the memory 104 include computer-readable storage media for storing computer-executable instructions (i.e., software) including the OS 132, the code 10, the compiler 134, the GP executable files 136, and the DP executable files 138. The instructions may be executed by the computer system 100 to perform the above-described functions and methods of the OS 132, the code 10, the compiler 134, the GP executable files 136, and the DP executable files 138.

The memory 104 stores instructions and data received from the PEs 102, the input/output devices 106, the display devices 108, the peripheral devices 110, the network devices 112, and the compute engine 120. The memory provides the stored instructions and data to the PEs 102, the input/output devices 106, the display devices 108, the peripheral devices 110, the network devices 112, and the compute engine 120. Examples of the storage devices of the memory 104 include magnetic and optical disks such as hard disk drives, random access memory (RAM), read-only memory (ROM), flash memory drives and cards, and CDs and DVDs.

The input/output devices 106 include any suitable type, number, and configuration of input/output devices configured to input instructions or data from a user to the computer system 100 and output instructions or data from the computer system 100 to the user. Examples of the input/output devices 106 include a keyboard, a mouse, a touchpad, a touchscreen, buttons, dials, knobs, and switches.

The display devices 108 include any suitable type, number, and configuration of display devices configured to output textual and/or graphical information to a user of the computer system 100. Examples of the display devices 108 include a monitor, a display screen, and a projector.

The peripheral devices 110 include any suitable type, number, and configuration of peripheral devices configured to operate together with one or more other components of the computer system 100 to perform general or special processing functions.

The network devices 112 include any suitable type, number, and configuration of network devices configured to allow the computer system 100 to communicate via one or more networks (not shown). The network devices 112 may operate based on any suitable networking protocol and/or configuration for allowing information to be transmitted from the computer system 100 to a network or received by the computer system 100 from the network.

The compute engine 120 is configured to execute the DP executable files 138, and includes the DP-optimal compute nodes 121. Each of the DP-optimal compute nodes 121 includes the PEs 122 and the memory 124 for storing the DP executable files 138.

The PEs 122 of the DP-optimal compute nodes 121 execute the DP executable files 138 and store results generated by the DP executable files 138, in the memory 124.

Each DP-optimal compute nodes 121 refers to a compute node which has one or more computing resources having a hardware architecture optimized for data-parallel computing (i.e., execution of a DP program or algorithm). The DP-optimal compute node 121 may include, for example, a node in which a set of the PEs 122 include one or more GPUs, and a node in which a set of the PEs 122 include a set of SIMD units in a general-purpose processor package.

The host 101 forms a host compute node configured to provide the DP executable files 138 to the DP-optimal compute nodes 121 using the interconnections 114 to execute the DP executable files 138, and receive results generated by the DP executable files 138, using the interconnections 114. The host compute node includes a collection of the general-purpose PEs 102 which share the general-purpose PEs 102. The host compute node may be configured using a symmetric multiprocessing architecture (SMP) and configured to maximize memory locality of the memory 104 using, for example, a non-uniform memory access (NUMA) architecture.

The OS 132 of the host compute node is configured to execute a DP call site to allow the DP executable files 138 to be executed by the DP-optimal compute nodes 121. When the memory 124 is separate from the memory 104, the host compute node allows the DP executable files 138 to be copied from the memory 104 to the memory 124. When the memory 104 includes the memory 124, the host compute node may designate a copy of the DP executable files 138 in the memory 104 as the memory 124, or may copy the DP executable files 138 from a part of the memory 104 to another part of the memory 104 configured as the memory 124. The copy process between the DP-optimal compute nodes 121 and the host compute node may serve as a synchronization point unless designated to be asynchronous.

The host compute node and each DP-optimal compute node 121 may independently and simultaneously execute code. The host compute node and each DP-optimal compute node 121 may interact at synchronization points to coordinate node computations.

In an embodiment, the compute engine 120 represents a graphics card in which one or more graphics processing units (GPUs) include the PEs 122 and the memory 124 which is separate from the memory 104. In this embodiment, a driver of a graphics card (not shown) may transform byte code or another intermediate language (IL) of the DP executable files 138 into an instruction set of the GPUs to be executed by the PEs 122 of the GPUs.

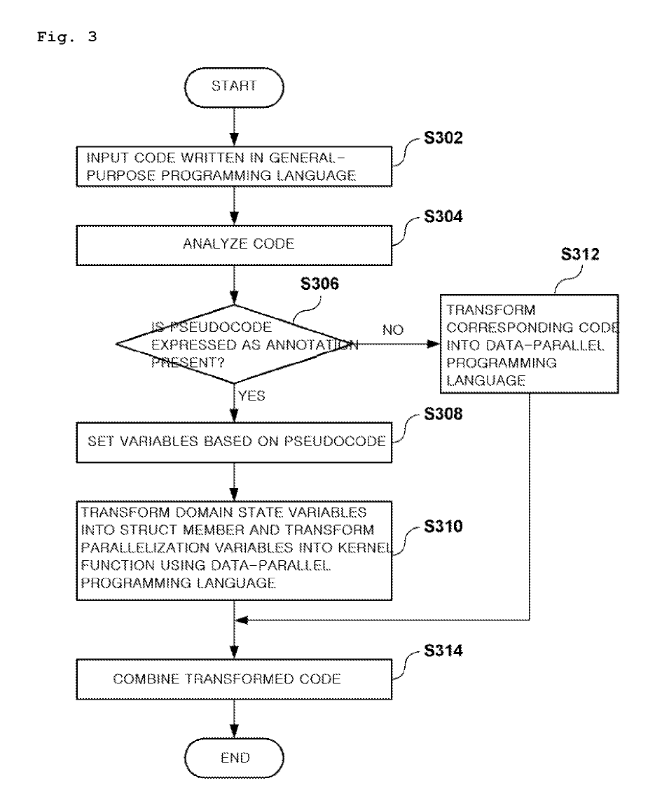

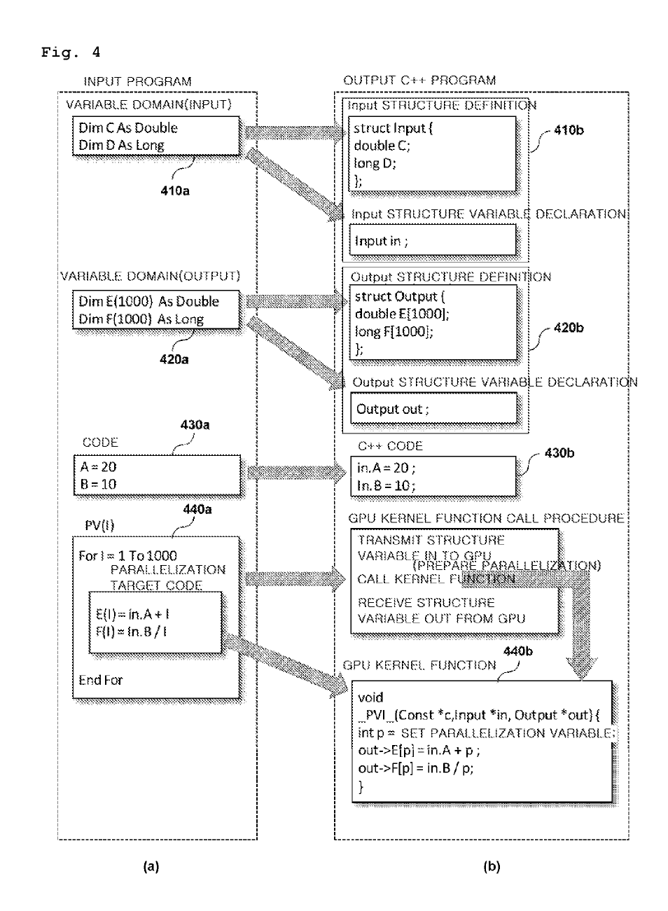

FIG. 3 is a flowchart of a method of transforming a program using annotation-based pseudocode by a host, according to an embodiment of the present invention, and FIG. 4 shows an example of a program for describing a method of transforming a program using annotation-based pseudocode, according to an embodiment of the present invention.

Referring to FIG. 3, when code written in a general-purpose programming language is input (S302), a host analyzes the input code (S304), to determine whether pseudocode expressed as an annotation is present (S306).

If the result of determination of S306 indicates that pseudocode is present, the host sets variables based on the pseudocode (S308). That is, the host sets domain state variables (e.g., CONST, INPUT, and OUTPUT) and a parallelization variable (e.g., PV).

Then, the host transforms code belonging to a domain state variable domain into a struct structure member using a data-parallel programming language configured to be executed by one or more DP-optimal compute nodes, and transforms code belonging to a parallelization variable domain into a kernel function using the data-parallel programming language (S310).

If the result of determination of S306 indicates that pseudocode is not present, the host transforms corresponding code into host code of the data-parallel programming language (S312).

Thereafter, the host generates code written in the data-parallel programming language by combining the code transformed in S310 and S312 (S314). In this case, in the generated code, the kernel function is processed in parallel by the DP-optimal compute nodes, and the host code is not processed in parallel.

For example, referring to FIG. 4, when a program illustrated in (a) is input, the host transforms variables belonging to an INPUT variable domain 410a into GPU C++ as illustrated in 410b of (b), defines the same as a struct structure member, and replaces variable declarations with INPUT structure variable declarations. Furthermore, the host transforms variables belonging to an OUTPUT variable domain 420a into GPU C++ as illustrated in 420b of (b), defines the same as a struct structure member, and replaces variable declarations with OUTPUT structure variable declarations. The host transforms variables belonging to a domain 430a not defined as pseudocode into GPU C++ as illustrated in 430b of (b). In addition, the host transforms variables belonging to a PV variable domain 410a into a kernel function using GPU C++ as illustrated in 440b of (b).

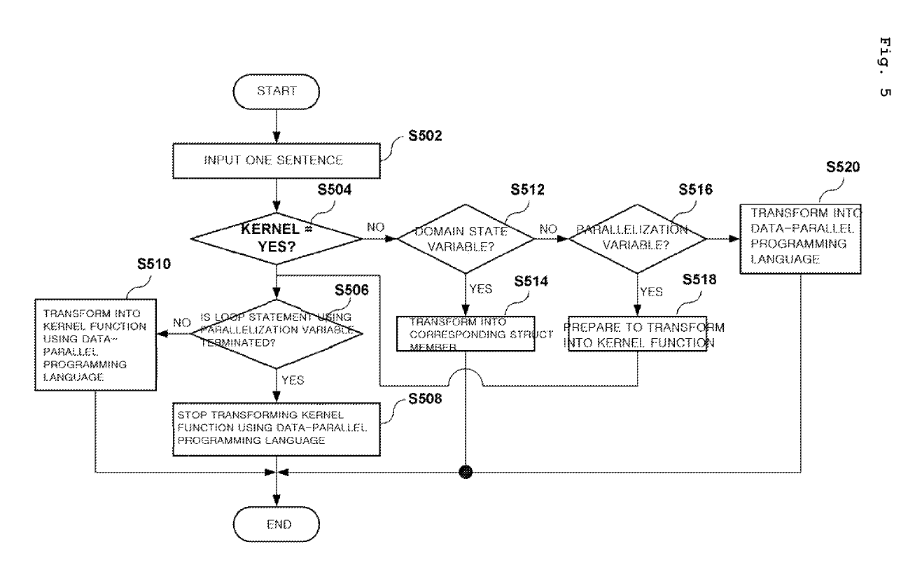

FIG. 5 is a flowchart of a method of transforming code written in a general-purpose programming language into code written in a data-parallel programming language, according to an embodiment of the present invention.

Referring to FIG. 5, when one sentence of code written in a general-purpose programming language is input (S502), a host determines whether the sentence corresponds to a kernel function (S504).

If the result of determination of S504 indicates that the sentence corresponds to a kernel function, the host determines whether a loop statement using a parallelization variable is terminated (S506).

If the result of determination of S506 indicates that the loop statement is terminated, the host stops transforming the kernel function using a data-parallel programming language (S508). If the loop statement is not terminated, the host transforms corresponding code into a kernel function using the data-parallel programming language (S510).

If the result of determination of S504 indicates that a kernel function is not being output, the host determines whether the sentence corresponds to a domain state variable domain (S512). That is, the host determines whether the sentence corresponds to a domain defined by a domain state variable such as CONST, INPUT, or OUTPUT.

If the result of determination of S512 indicates that the sentence corresponds to the domain state variable domain, the host transforms the corresponding code into a struct structure member using the data-parallel programming language (S514).

If the result of determination of S512 indicates that the sentence does not correspond to the domain state variable domain, the host determines whether the sentence corresponds to a parallelization variable domain (S516).

If the result of determination of S516 indicates that the sentence corresponds to the parallelization variable domain, the host prepares to transform the corresponding code into a kernel function (S518), and performs S504.

If the result of determination of S516 indicates that the sentence does not correspond to the parallelization variable domain, the host transforms the corresponding code into host code of the data-parallel programming language (S520).

The above-described method of transforming a program using annotation-based pseudocode can be implemented as a program, and code and code segments for configuring the program can be easily construed by programmers of ordinary skill in the art. In addition, the program for executing the method of transforming a program using annotation-based pseudocode can be stored in electronic-device-readable data storage media, and can be read and executed by an electronic device.

While the present invention has been particularly shown and described with reference to embodiments thereof, it will be understood by one of ordinary skill in the art that various changes in form and details may be made therein without departing from the spirit and scope of the invention as defined by the following claims. The exemplary embodiments should be considered in a descriptive sense only and not for purposes of limitation. Therefore, the scope of the invention is defined not by the detailed description of the invention but by the following claims, and all differences within the scope will be construed as being included in the present invention.

### DESCRIPTION OF REFERENCE NUMERALS

100: Computer System 101: Host

120: Compute Engine

1. A method of transforming a program using annotation-based pseudocode by a computer system, the method comprising:
analyzing code written in a general-purpose programming language, to check pseudocode expressed as an annotation;
transforming code belonging to a pseudocode domain into a struct structure member or into a kernel function using a data-parallel programming language configured to be executed by one or more data-parallel (DP)-optimal compute nodes, and transforming code belonging to another domain into host code of the data-parallel programming language, to generate code written in the data-parallel programming language; and
simultaneously executing the kernel function of the generated code using the DP-optimal compute nodes.

2. The method according to claim 1, wherein the pseudocode comprises a domain state variable or a parallelization variable,
wherein code belonging to a domain state variable domain is transformed into the struct structure member using the data-parallel programming language, and
wherein code belonging to a parallelization variable domain is transformed into the kernel function using the data-parallel programming language.

3. A computer-readable recording medium having recorded thereon a program for executing a method of transforming a program using annotation-based pseudocode by a computer system, the method comprising:
analyzing code written in a general-purpose programming language, to check pseudocode expressed as an annotation;
transforming code belonging to a pseudocode domain into a struct structure member or into a kernel function using a data-parallel programming language configured to be executed by one or more data-parallel (DP)-optimal compute nodes, and transforming code belonging to another domain into host code of the data-parallel programming language, to generate code written in the data-parallel programming language; and
simultaneously executing the kernel function of the generated code using the DP-optimal compute nodes.
